(19) United States
(12) Patent Application Publication
(10) Pub. No.: US 2013/0089698 A1
(43) Pub. Date: Apr. 11, 2013

(54) Portable And Disposable Potti-Drape Device

(71) Applicant: Beverly Ann Perales, Midland, TX (US)

(72) Inventor: Beverly Ann Perales, Midland, TX (US)

(21) Appl. No.: 13/341,897

(22) Filed: Dec. 30, 2011

Related U.S. Application Data
(60) Provisional application No. 61/545,383, filed on Oct. 10, 2011.

(51) Int. Cl. B32B 3/06

(52) U.S. Cl. 428/99

(57) ABSTRACT

The present disclosure provides for a portable and disposable device for increasing privacy in a stall and includes a drape for covering a gap or aperture in the construct of the stall, at least one adhesive element that is attached to the drape for adhering the drape to the stall, and a packaging unit for repositing one or more drapes therein to store before use, thereby providing easy transportability of the device.

### CROSS-REFERENCE TO RELATED APPLICATIONS

Applicant claims priority to U.S. Provisional Patent Application No. 61/545,383, filed Oct. 10, 2011, the disclosure of which is incorporated by reference herein in its entirety.

### DESCRIPTION OF THE DRAWINGS

FIG. 1 is a perspective view of the front portion of a packaging unit having one or more drapes contained therein comprising an embodiment of the present invention;

FIG. 2 is a perspective view of the back portion of the packaging unit of FIG. 1;

FIG. 3 is a perspective view of the back portion of the packaging unit of FIG. 2 with the jacket open and a drape exposed and ready for removal;

FIG. 4 is a perspective view of a drape being removed from a packaging unit;

FIG. 5 is a view of the back portion of a drape;

FIG. 6 is a view of the front portion of a drape;

FIG. 7A is a view of the back portion of a drape wherein the drape includes one adhesive element comprising an embodiment of the present invention;

FIG. 7B is a view of the back portion of a drape wherein the drape includes more than one adhesive elements comprising an embodiment of the present invention;

FIG. 8A is a perspective view of a stall positioned inside a public restroom wherein the stall includes inherent gaps in its construct;

FIG. 8B is a perspective view of the stall of FIG. 8A wherein two drapes have been attached to the stall to cover over the inherent gaps in the stall's construct, thereby providing increased individual privacy within the stall; and

FIG. 8C is a perspective view of the stall of FIG. 8B wherein several drapes have been attached to the stall to maximize individual privacy.

### BACKGROUND OF THE INVENTION

Privacy is essentially an innate and inherent desire possessed by most, if not all, individuals. Individualism engenders a proclivity for a measure of personal privacy. As such, society highly values privacy, especially in certain daily activities. Examples of daily activities in which privacy is highly valued include the contents of a diary or journal comprising the writer's intimate or personal thoughts, communication between spouses in a marriage, an attorney and a client, or a physician and a patient. Furthermore, information can be considered private such as a person's social security number or medical history. As is evident, society places great importance on an individual's right to a measure of privacy. It is for this reason that governments around the world, including the United States, have codified into law a right to a measure of privacy for individuals.

Privacy laws are instituted not only to protect individuals but also to acknowledge and enforce a social decency and implicit social compact that members of society bestow one to another. This social decency and implicit compact is apparent in current societal standards relating to the amount and portions of an individual's body that can be exposed when in public. As such, an individual complies with such standards by wearing an appropriate amount of clothing to cover the private portions of the body, thereby maintaining the individual's privacy.

Furthermore, this social decency and implicit compact also is apparent when an individual removes himself/herself temporarily from public view to expel waste from the body. In doing so, an individual will seek seclusion in a restroom or other similar room that has one or more commodes or like devices.

A restroom provides privacy and seclusion from the public. If a restroom supports the use of several individuals at one time (i.e., by having several commodes such as in a public restroom), generally it is partitioned so that privacy is maintained for each of the several individuals that it supports. These partitions are often called stalls and are usually constructed around each commode within a restroom, thereby providing each individual who is utilizing a commode with a measure of privacy. Generally, a stall will have several sides (i.e., walls) and a door. Inside a stall is a commode. Once an individual enters a stall, the individual typically closes and locks the door for maximum privacy.

While a stall provides a measure of privacy and seclusion, often times it is poorly constructed. As a result, it may have one or more gaps and/or apertures in its construct that allow others that are exterior to the stall to see into the stall's interior, thereby exposing the individual within the stall and reducing the individual's privacy. A gap and/or an aperature can exist within any part of the stall's construct. For example, a gap can exist at the meeting point where two of the walls of a stall come together or between a stall's wall and a stall's door due to a hinge or lock. Also, if the material that comprises the construct of the stall has been damaged, an aperture can exist within a wall or door of the stall, thereby exposing the individual within the stall and reducing the individual's privacy.

Because of the gaps and/or apertures that can exist, privacy for the individual within the stall is reduced. This reduction of privacy can result in discomfort for the individual within the stall as well as for others exterior to the stall. In some cases, the gaps cannot easily be corrected due to the specific construct of the stall. For example, if the stall's door is attached via a hinge, generally a gap results that is inherent.

What is needed is a device that increases and maximizes an individual's privacy within a stall. More specifically, what is needed is a portable and disposable device that easily, quickly and affordably obstructs the vision between the interior and exterior of a stall due to any gaps and/or apertures within the stall's constructs. Additionally what is needed is a portable and disposable device that easily and quickly allows an individual in a stall to maximize his or her privacy therein by eliminating the ability of others exterior to the stall to view the stall's interior through any gaps and/or apertures.

A portable and disposable potti-drape device, having embodiments disclosed herein, is a novel invention that, inter alia, meets the needs described in the above paragraph while also providing many substantial advantages such as compact packaging and storage, affordability, easy of use, and disposability. Each embodiment of the device provides for simple and easy packaging, storage and transportation of the invention. As such, the present invention can be placed in a purse or pocket for easy transportation and storage until needed. Additionally, because of its abundant and inexpensive composite materials, embodiments of the present invention are affordable and economical to manufacture and assemble.

The present invention is profoundly simple in its use but simply profound in its innovative qualities. For example, once an individual desires increased privacy in a stall because of gap(s) and/or aperture(s) due to the stall's constructs, a drape can be affixed to the portion of the stall having an opening, gap or aperture, thereby preventing others located at the exterior to the stall from seeing into the stall's interior through such opening, gap or aperture. At the conclusion of its use—presumably at the time when the individual is ready to exit the stall, the drape can be detached from the stall and discarded.

Innovative features of the present invention include disposability. For example, once removed and/or detached from a stall, the drape can be discarded into a waste basket or more conveniently into a commode that is located within the stall where it can be flushed. An individual can exit the stall without having to transport the drape to a waste basket. Because an individual's exposure to the drape is reduced as it can simply be placed in the commode instead of a waste basket, the individual will save time. Thus, the present invention reduces time inefficiency. It also decreases the amount of time that an individual would be in contact with a used drape.

Each drape can be constructed having a dimension of a predetermined length and width. However, the preferred dimension is a width of four inches and a length of twenty inches. Each drape is comprised of material that impedes and/or inhibits a person's ability to see through it.

In the present invention, initially one or more drapes are contained within a packaging unit for easy storage and transportation. An individual can simply carry the packaging unit in his or her purse, pocket or other similar carrying device. When an individual wishes to cover a gap or an aperture in a stall, the individual simply removes one or more drapes from the packaging unit and attaches it to the stall in such a way that it covers the gap and/or aperture.

In one embodiment of the present invention, the top portion of the back of a drape comprises an adhesive element that causes that top portion to adhere to a stall thereby causing the drape to cover a gap and/or aperture. In another embodiment of the present invention, the top portion and the bottom portion of a drape each comprise an adhesive element that cause both the top portion and the bottom portion to adhere to a stall thereby causing the drape to cover a gap and/or aperture. Because multiple portions comprise adhesive elements, the drape affixes to the stall more firmly. At the conclusion of its use, the drape can be removed from the stall by detaching its adhesive elements from the stall and placing the drape in a commode or waste basket for disposable purposes. This process can be repeated when necessary until all of the drapes in a packaging unit have been removed, used and/or discarded.

### DETAILED DESCRIPTION OF THE INVENTION

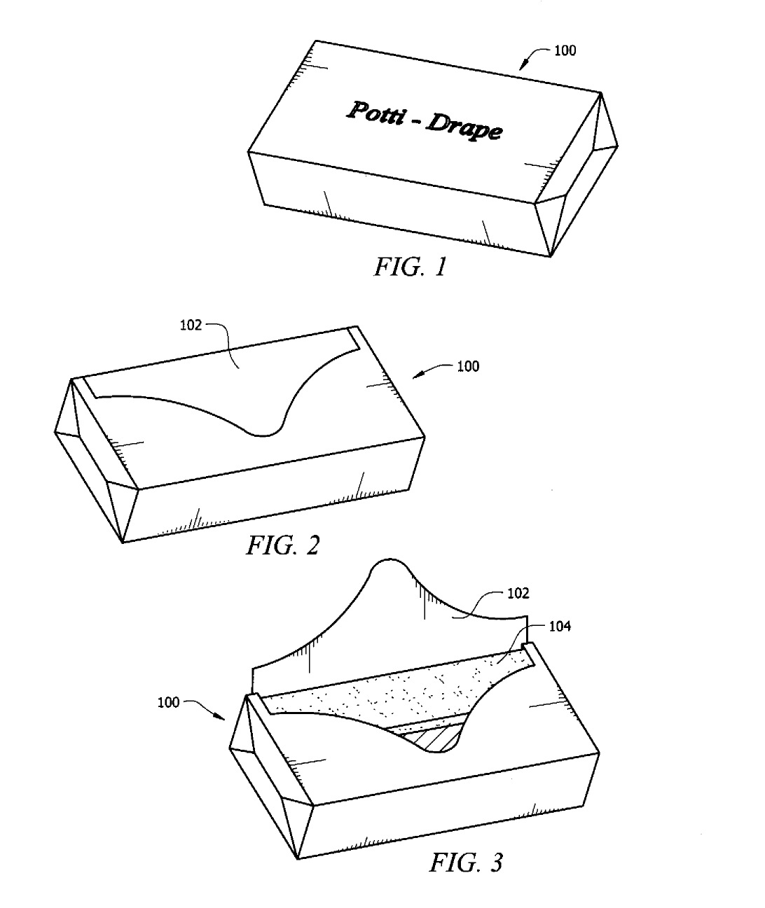

Turning now to FIG. 1, an illustration is shown that depicts a packaging unit 100 containing one or more drapes. The packaging unit 100 is a compact repository and can be constructed from any material. For example, the packaging unit 100 can be constructed from materials such as but not limited to polymer, plastic, paper, etc.

FIG. 2 depicts the back portion of the packaging unit 100 having a jacket 102 that can be opened or closed to provide quick and easy access to the drapes within the packaging unit 100. In FIG. 2, the jacket 102 is shown in a closed position. FIG. 3 depicts the jacket 102 in an open position, exposing a portion of a drape 104 that is within the packaging unit 100.

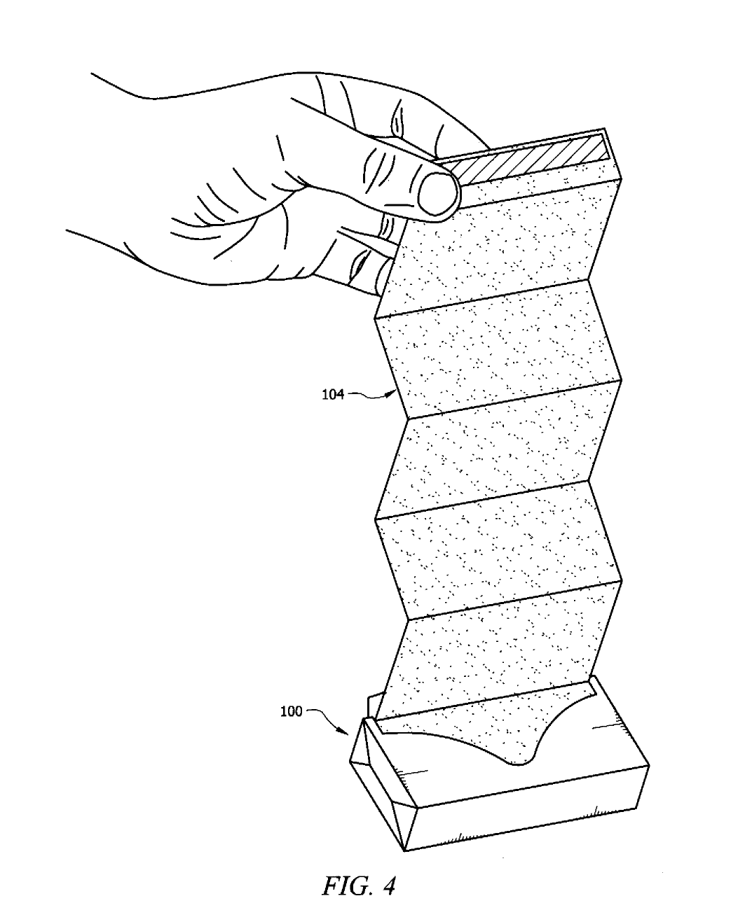

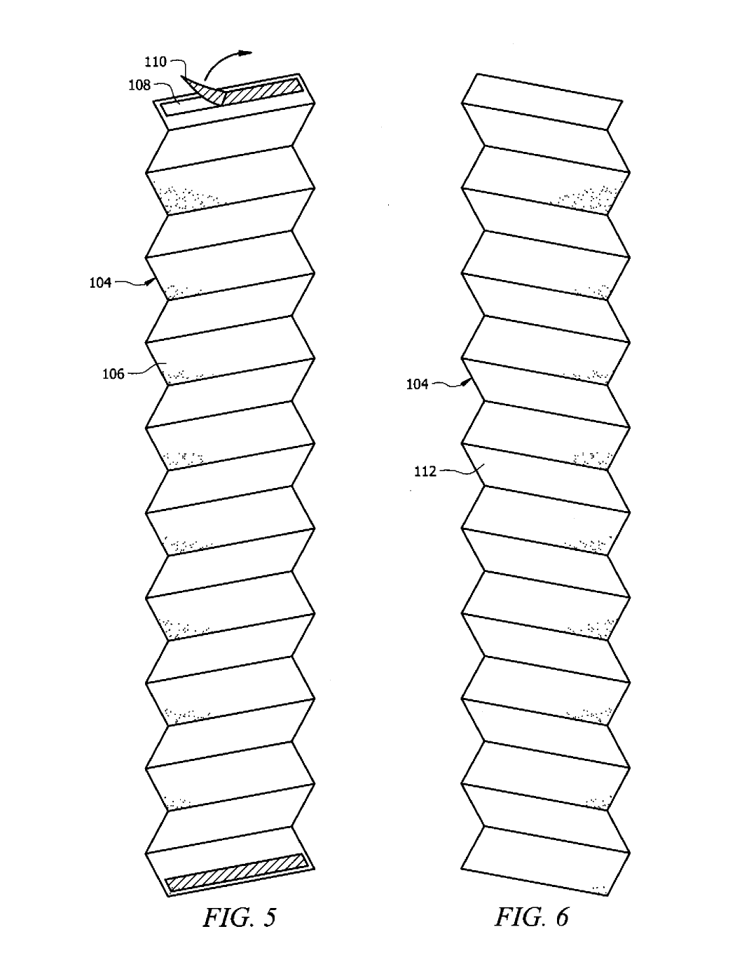

FIG. 4 illustrates a drape 104 being removed from the packaging unit 100. The drape 104 can be positioned and stored within the packaging unit 100 in a variety of ways. However, to compactly store several drapes within the packaging unit 100, each drape can be folded in such a way as to minimize each drape's spatial area. In order to minimize a drape's spatial area within a packaging unit 100, a drape 104 can be folded in an accordion fashion when stored in the packaging unit 100. Therefore, when removed from the packaging unit 100, the drape 104 will unfold in an accordion arrangement as it exits the packaging unit 100 as shown in FIG. 4. However, it should be noted that a drape 104 can be folded into the packaging unit 100 in a variety of ways.

FIG. 5 illustrates the back 106 of a drape 104. The back 106 of the drape 104 comprises one or more adhesive elements 108. A protective strip 110 covers each adhesive element 108, preventing the exposure of the adhesive element 108 until it is ready for use. To attach the drape 104 to a portion of a stall, the protective strip 110 is removed by peeling it off of the adhesive element 108, thereby exposing the adhesive element 108. Then, the back 106 of the drape 104 is positioned over a gap and/or aperture and the adhesive element 108 of the drape 104 is attached to a stall.

FIG. 6 illustrates the front 112 of the drape 104. The drape 104 can be comprised of any material that inhibits visibility through the drape 104. Any material that impedes a person's ability to see through the drape 104 is suitable. For example, the drape 104 can constitute a polymer, plastic, paper, etc. Persons of ordinary skills in this particular art will appreciate that toilet paper can be used as the dominant construct of the drape 104. Toilet paper is abundant, cost-effective, and easy to manufacture. By utilizing toilet paper as the construct, the drape 104 can be placed in the commode and flushed at the conclusion of its use without further negatively affecting the environment. Furthermore, the adhesive element 108 can be constructed of material that also can be flushed down the commode without negatively affecting the environment.

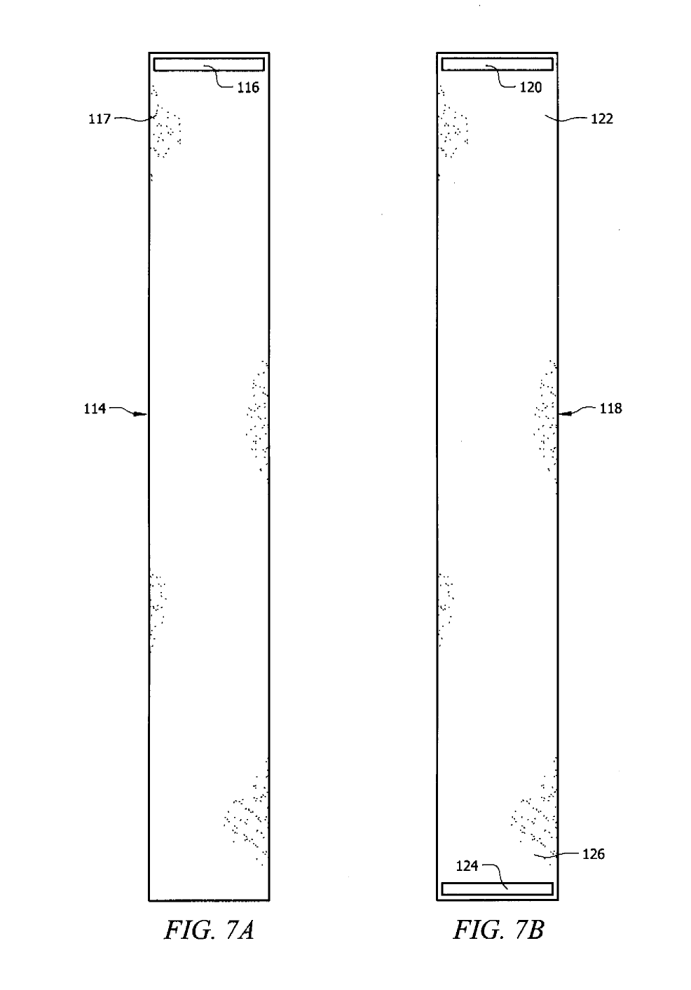

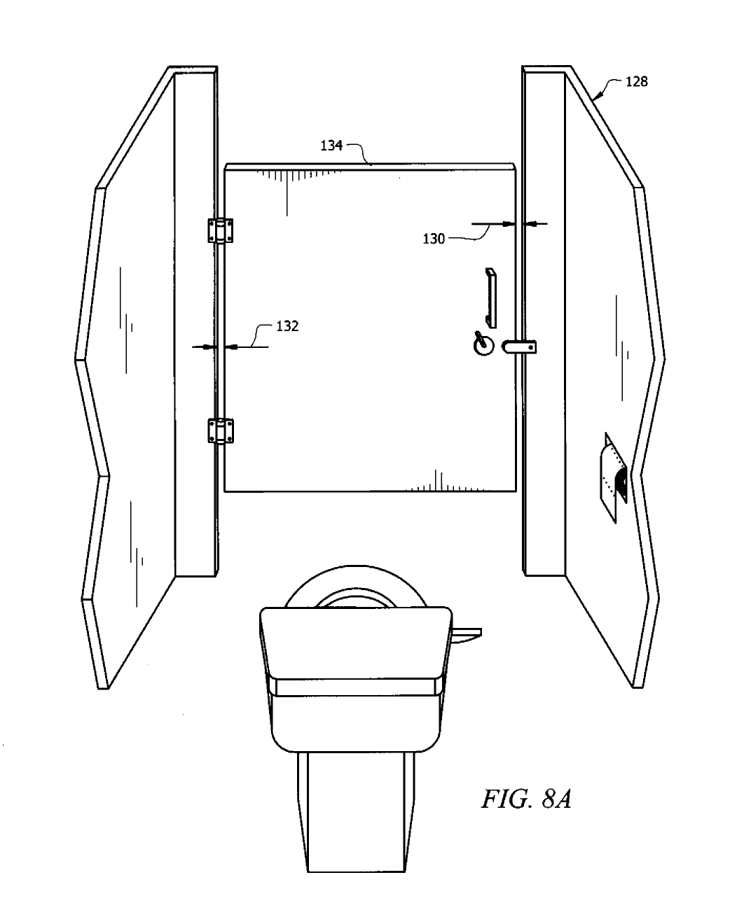

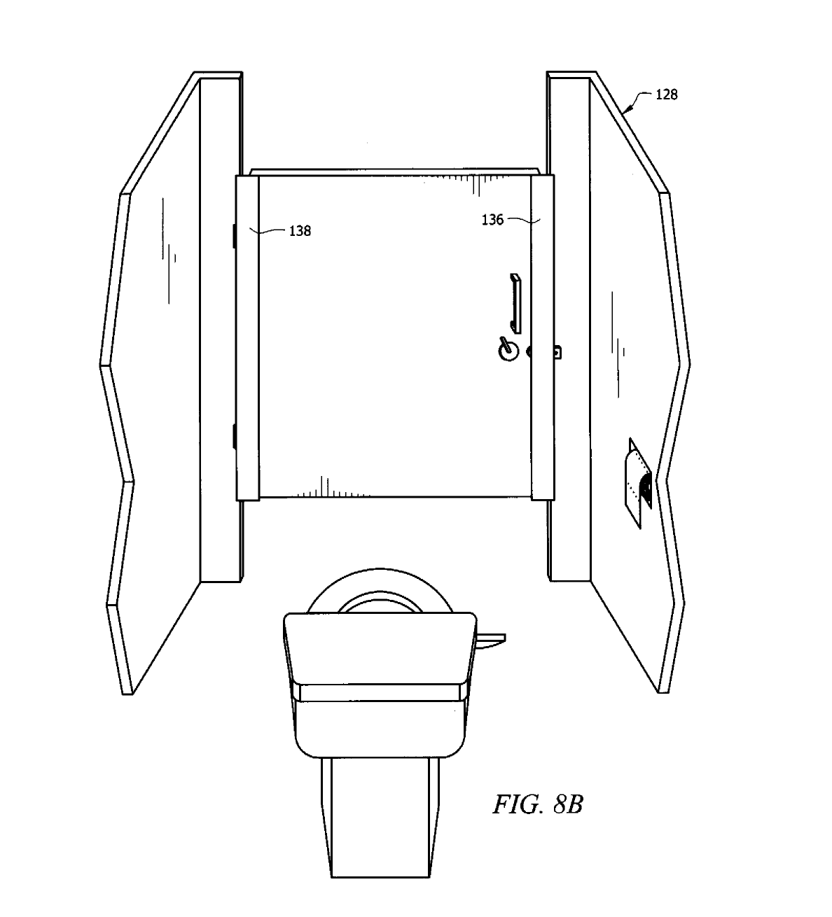

FIG. 7A illustrates an embodiment of the present invention. FIG. 7A depicts the back portion of a drape 114 having only one adhesive element 116. The drape 114 may comprise a protective strip. The protected strip can be removed from the adhesive element 116, thereby allowing the drape 114 to adhere to a stall. Typically, the adhesive element 116 will be positioned near the top portion 117 of the drape 114 so that once the top portion 117 of the drape 114 adheres to the stall, the remaining portions of the drape 114 will hang downward, covering a gap and/or aperture.

FIG. 7B illustrates another embodiment of the present invention, an embodiment comprising more than one adhesive element positioned on the back of a drape 118. For example, FIG. 7B depicts a back portion of a drape 118 having an adhesive element 120 positioned at the top portion 122 of the drape 118 and a adhesive element 124 position at the bottom portion 126 of the drape 118. Each protective element can comprise a protective strip. The protective strip can be removed from each protective element, thereby allowing the drape 118 to adhere to a stall. In this embodiment, the top portion 122 and bottom portion 126 of the drape 118 will adhere to the stall. Therefore, the drape 118 is not required to hang but can be positioned horizontally, or in any other position, to cover a wide gap and/or aperture. The dual adhesive elements provide maximum control over the drape 118 when affixing it to a stall.

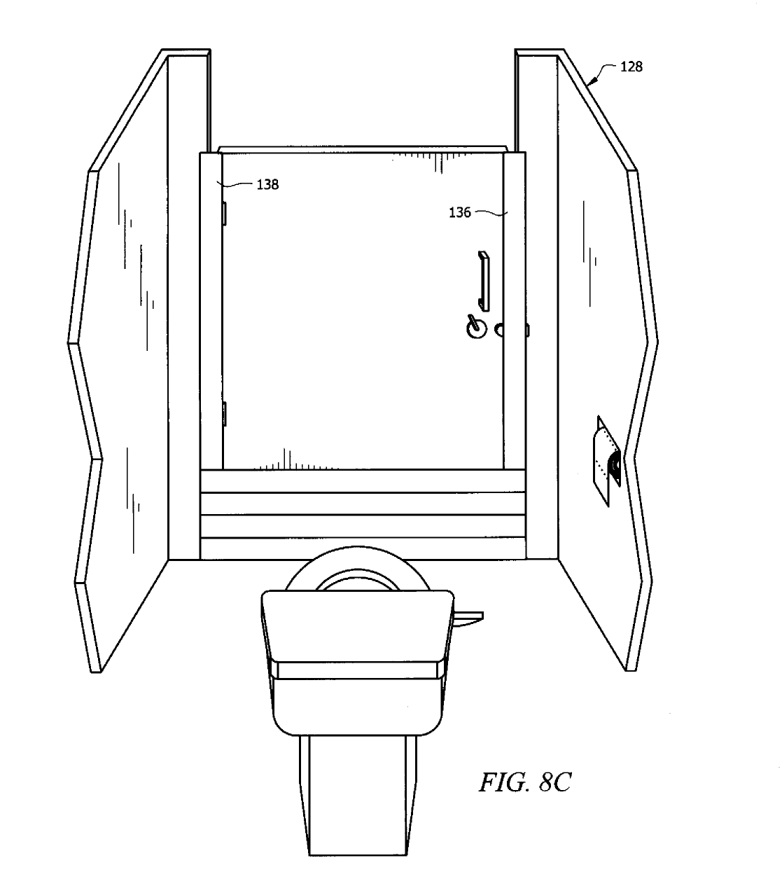

FIG. 8A illustrates a typical stall 128 in a typical public restroom. The construct of the stall 128 comprises inherent gaps that allow other individuals located outside to the stall 128 to see inside the stall 128 through gaps and/or apertures. Specifically, locking mechanism gap 130 and hinge mechanism gap 132 exist on each side of the door 134 of the stall 128 and are inherent in the construct of the stall 128.

FIG. 8B illustrates two drapes in use. A first drape 136 is attached to the stall 128, covering the locking mechanism gap 130. A second drape 138 is attached to the stall 128, covering the hinge mechanism gap 132. As a result, an individual inside the stall 128 has increased his or her privacy by preventing other individuals outside the stall 128 from seeing inside the stall 128 through the locking mechanism gap 130 and the hinge mechanism gap 132.

FIG. 8C illustrates differing ways that a drape can be positioned and used. For example in FIG. 8C, several drapes have been affixed to the stall 128 to maximize privacy. Once an individual inside the stall 128 is ready to exit, he or she may detach each drape and place each drape in the commode where it can be flushed or place each drape in a waste basket for disposal.

Although many embodiments of the present invention have been illustrated in the accompanying Drawings and described in the foregoing Detailed Description, it should be understood that the present invention is not limited to the embodiments disclosed, but is capable of numerous rearrangements, modifications, and substitutions of parts and elements without departing from the spirit of the invention.

What is claimed is:

1. A portable and disposable device for increasing privacy in a stall, the device comprising:
a drape for covering a gap or aperture in the construct of the stall; and
at least one adhesive element attached to the drape for adhering the drape to the stall.

2. The portable and disposable device of claim 1 wherein the drape is comprised of material that inhibits visibility therethrough.

3. The portable and disposable device of claim 2 wherein the drape is comprised of material that is disposable via a commode.

4. The portable and disposable device of claim 3 wherein the drape is constructed of toilet paper.

5. The portable and disposable device of claim 4 wherein the drape is four inches in width.

6. The portable and disposable device of claim 5 wherein the drape is twenty inches in length.

7. The portable and disposable device of claim 6 further comprising a removable protective strip that is attached to the adhesive element for preventing the exposure of the adhesive element until the drape is ready to be attached to the stall.

8. The portable and disposable device of claim 7 wherein the protective strip is comprised of material that is disposable via a commode.

9. The portable and disposable device of claim 8 further comprising a packaging unit for repositing one or more drapes therein before use, thereby providing easy transportability of the device.

10. A portable and disposable device for increasing privacy in a stall, the device comprising:
a drape for covering a gap or aperture in the construct of the stall; and
a means for attaching the drape to the stall.

11. The portable and disposable device of claim 10 wherein the drape is comprised of material that inhibits visibility therethrough.

12. The portable and disposable device of claim 11 wherein the drape is comprised of material that is disposable via a commode.

13. The portable and disposable device of claim 12 wherein the drape is constructed of toilet paper.

14. The portable and disposable device of claim 13 wherein the drape is four inches in width.

15. The portable and disposable device of claim 14 wherein the drape is twenty inches in length.

16. The portable and disposable device of claim 15 further comprising a removable protective strip that is attached to the adhesive element for preventing the exposure of the adhesive element until the drape is ready to be attached to the stall.

17. The portable and disposable device of claim 16 wherein the protective strip is comprised of material that is disposable via a commode.

18. The portable and disposable device of claim 17 further comprising a packaging unit for repositing one or more drapes therein before use, thereby providing easy transportability of the device.

19. A portable and disposable device for increasing privacy in a stall, the device comprising:
a drape for covering a gap or aperture in the construct of the stall;
at least one adhesive element attached to the drape for adhering the drape to the stall; and
a packaging unit for repositing one or more drapes therein, thereby providing easy transportability of the device.
